(19) United States
(12) Patent Application Publication
(10) Pub. No.: US 2025/0096343 A1
(43) Pub. Date: Mar. 20, 2025

(54) BATTERY CELL

(71) Applicants: Volkswagen Aktiengesellschaft, Wolfsburg (DE); W. L. Gore & Associates GmbH, Putzbrunn (DE)

(72) Inventors: Tim DAGGER, Lingen (DE); Daniel KEGLMEIER, Putzbrunn (DE); Anton KILLER, Putzbrunn (DE); Paul MEISTER, Ilsede (DE); Joachim MUELLER, Putzbrunn (DE); Andreas SAENGER, Putzbrunn (DE); Piotr WRZUSZCZAK, Hannover (DE); Wenbo ZHANG, Calberlah (DE); Branislav ZLATKOV, Braunschweig (DE)

(73) Assignees: Volkswagen Aktiengesellschaft, Wolfsburg (DE); W. L. Gore & Associates GmbH, Putzbrunn (DE)

(21) Appl. No.: 18/965,542

(22) Filed: Dec. 2, 2024

Related U.S. Application Data
(63) Continuation of application No. PCT/EP2023/061774, filed on May 4, 2023.

(30) Foreign Application Priority Data
May 30, 2022 (DE) 10 2022 205 365.6

(51) Int. Cl. H01M 10/52; B60L 50/60; H01M 50/103; H01M 50/15; H01M 50/16; H01M 50/30; H01M 50/342

(52) U.S. Cl. CPC H01M 10/52; H01M 50/103; H01M 50/15; H01M 50/16; H01M 50/3425; H01M 50/394; B60L 50/60; H01M 2220/20

(57) ABSTRACT

A battery cell having a cell casing in which a number of electrodes are arranged. The cell casing has an opening that is is covered by a gas-permeable membrane. An exterior of the membrane is covered by a cover element in order to restrict the ingress of matter into the cell casing.

This nonprovisional application is a continuation of International Application No. PCT/EP2023/061774, which was filed on May 4, 2023, and which claims priority to German Patent Application No. 10 2022 205 365.6, which was filed in Germany on May 30, 2022, and which are both herein incorporated by reference.

### BACKGROUND OF THE INVENTION

### Field of the Invention

The invention relates to a battery cell. The battery cell has a cell housing in which multiple electrodes are situated.

### Description of the Background Art

Motor vehicles are being increasingly driven, at least in part, by an electric motor, so that these motor vehicles are designed as an electric vehicle or hybrid vehicle. A high-voltage battery that includes multiple individual battery modules is generally used to supply the electric motor with power. The battery modules usually have an identical design and are electrically connected to one another in series and/or in parallel, so that the voltage present at the high-voltage battery corresponds to a multiple of the voltage that is provided by each of the battery modules. Each battery module in turn includes multiple battery cells that are usually situated in a shared module housing, and electrically connected to one another in series and/or in parallel.

Each of the battery cells in turn generally includes multiple galvanic elements. These galvanic elements each have two electrodes, namely, an anode and a cathode, as well as a separator situated in between and an electrolyte with freely movable charge carriers. For example, a liquid is used as such an electrolyte. In one alternative, the battery cell is designed as a solid-state battery, and the electrolyte is present as a solid. The anode and the cathode, which form the electrodes of the battery cell, typically include a carrier that functions as a current collector. An active material that is a component of a layer applied to the carrier, also referred to as an arrester, is generally affixed to the carrier. It is possible for the electrolyte to already be present in the layer, or for the electrolyte to be subsequently introduced. However, the active material is suitable at least for absorbing the working ions, for example lithium ions. Depending on the use as an anode or a cathode, another material is used for the carrier, and a different type of material is used as the layer.

For protection of the galvanic elements, they are generally situated in a cell housing of the battery cell, which in some cases is also referred to as a cell can. In addition, the cell housing protects in particular the electrolyte as well as other components from environmental influences. In order to provide a comparatively large capacity by use of the particular battery cell, multiple such galvanic elements, generally up to 100, are situated in the shared cell housing. To utilize the available space comparatively efficiently and simplify manufacture, the individual components of the galvanic elements have a flat design and are stacked one on top of the other in a stacking direction, so that an essentially square cell stack is formed. The separator can have a band-shaped design, and on opposite sides is provided in each case with multiple electrodes. The band is wound up to form a roll, in particular a so-called “jelly roll.”

The shape of the cell housing depends on the configuration of the galvanic elements that are used. It is possible for the cell housing to have a rigid design and to be made of aluminum, for example. In this case the shape of the cell housing is square, for example. This type of battery cell is also referred to as a prismatic cell. The cell housing can be produced using a film that is pressed against and around the galvanic elements. Such a battery cell is also referred to as a so-called pouch cell.

During operation of the battery cell, i.e., during charging and also discharging, it is possible for gases to arise as the result of undesirable chemical reactions. This causes a pressure increase inside the cell housing, so that on the one hand some electrode areas may have poorer ion conduction, resulting in power loss in the battery cell. On the other hand, it is possible for the cell housing to be deformed due to the increased pressure, so that in particular the surroundings of the battery cell are mechanically influenced. At a comparatively high pressure the cell housing bursts, so that the electrolyte can escape and the entire battery cell is no longer ready for operation. It is also possible for undesirable chemical reactions of the individual components of the battery cell to take place with the surroundings.

Minimizing such gas formation requires a specific combination of the individual materials of the electrodes and of the electrolyte, which on the one hand increases manufacturing costs. On the other hand, the selection of less reactive electrode materials is often accompanied by a reduction of capacity and/or energy density. As an alternative, additional elements are present in the cell housing, for example, by means of which the gases that arise are bound and/or reacted. However, the additional elements increase the installation space and also the weight of the battery cell, thereby reducing the energy density.

### SUMMARY OF THE INVENTION

The object of the invention is to provide a particularly suitable battery cell in which operational reliability and/or energy density are/is advantageously increased.

The battery cell in particular has a rechargeable design, and advantageously is a secondary battery. The battery cell in the intended state is preferably an integral part of a motor vehicle. The battery cell is suited, in particular provided and configured, for this purpose. In the intended state the battery cell is, for example, a component of an energy store of the motor vehicle, which includes multiple such battery cells. The battery cells are preferably divided into multiple battery modules which have an identical design. The battery cells are in particular situated in a housing of the energy store or of the particular battery module, and electrically connected to one another in parallel and/or in series. The voltage present at the energy store/battery module is thus a multiple of the voltage that is provided by each of the battery cells. All battery cells advantageously have an identical design, which simplifies manufacture.

The housing of the energy store or of the particular battery module, which in a group can form a combination of such battery cells, is preferably made of a metal, for example a steel such as a stainless steel, or an aluminum alloy. For example, a pressure die casting process, a deep drawing process, autoforging, or extrusion is used for the manufacture. In particular, the housing of the energy store or of the particular battery module has a closed design. An interface that forms a terminal of the energy store/battery module is advantageously introduced into the housing of the energy store or of the particular battery module. The interface is electrically contacted by the battery cells, so that supplying of electrical energy to and/or removal of electrical energy from the battery cells from outside the energy store is possible, provided that an appropriate plug is inserted at the terminal.

The motor vehicle is preferably land-based and preferably has a number of wheels, of which at least one, suitably multiple or all, is/are driven by a drive. In particular, one, preferably several, of the wheels has/have a controllable design. It is thus possible to move the motor vehicle independently of a designated roadway, for example on rails or the like. It is advantageously possible to position the motor vehicle essentially in any desired manner on a roadway, which in particular is made of asphalt, tar, or concrete. The motor vehicle is a commercial vehicle, for example, such as a truck or a bus. However, the motor vehicle is particularly preferably a passenger car.

Movement of the motor vehicle advantageously takes place by means of the drive. For example, the drive, in particular the main drive, has an electrical design, at least in part, and the motor vehicle is an electric vehicle, for example. The electric motor is operated by means of the energy store, for example, which is suitably designed as a high-voltage battery. A direct voltage is advantageously provided by the high-voltage battery, wherein the voltage is between 200 V and 800 V, for example, and is essentially 400 V, for example. Preferably situated between the energy store and the electric motor is an electrical converter which adjusts the supplying of power to the electric motor. In one alternative, the drive additionally has an internal combustion engine, so that the motor vehicle is designed as a hybrid motor vehicle. In one alternative, a low-voltage vehicle electrical system of the motor vehicle is supplied with power by the energy store, and the energy store provides in particular a direct voltage of 12 V, 24 V, or 48 V.

In a further alternative, the battery cell is an integral part of a floor conveyor vehicle, an industrial facility, or a hand-operated device, for example a tool, in particular a cordless screwdriver. In a further alternative, the battery cell is an integral part of an energy supply, where it is used as a so-called buffer battery, for example. In a further alternative, the battery cell is an integral part of a portable device, for example a portable mobile telephone or some other wearable device. It is also possible to use such a battery cell in the areas of camping or model building, or for other outdoor activities.

The battery cell has multiple, for example two or preferably more, electrodes. In particular, the electrodes are divided into anodes and cathodes, with one-half of the electrodes advantageously forming the anodes, and the other half forming the cathodes. However, it is preferred that one more anode than cathode is present. All anodes and all cathodes particularly preferably have identical respective designs, which simplifies manufacture. The electrodes have a flat design, for example, and in particular include a carrier, also referred to as an arrester. In particular, the respective carrier is formed by a metal foil that is coated, at least in sections, with a layer on one or both sides. For example, aluminum is used as the metal of the carrier/arrester of the cathodes, and copper is used as the metal of the arrester of the anodes.

The layer has a thickness less than 1 mm. The carriers advantageously have a thickness less than 0.1 mm. The particular layer preferably includes an active material, a binder, and/or a conductive additive such as conductive carbon black. The active material is used for the absorption/release of working ions such as lithium ions, and is suited, in particular provided and configured, for this purpose. For example, a lithium-metal oxide such as lithium-cobalt (III) oxide (LiCoO2), or NMC, for example NMC622 or NMC811, NCA, LNMO, or Li-rich materials are used as active material for the cathode. Alternatives are olivines, for example, such as LFP. For the anode, for example graphite, Si-based materials or mixtures thereof, lithium metal, or LTO are used.

In particular, the electrodes are essentially rectangular. The electrodes are, for example, stacked one on top of the other to form a cell stack, the stacking direction being perpendicular to the direction of extension of the electrodes, which are situated in parallel to one another. The anodes and cathodes preferably alternate in the stacking direction of the cell stack. Advantageously situated in each case between neighboring electrodes, in particular between each of the anodes and each of the cathodes, is a separator of the cell stack, which preferably likewise has a flat design. For example, all separators have an identical design. In particular, the electrodes are stacked one on top of the other essentially in flush alignment, for example with all anodes protruding at least slightly beyond the cathodes. The cell stack is thus likewise essentially square due to the stacking of the electrodes.

For example all anodes, all cathodes, or the separator can be formed via a shared band, or are fastened to a shared band. The band itself is rolled up into a cylindrical shape or the like, so that a so-called “jelly roll” is formed.

The battery cell has a cell housing within which the electrodes are situated, for example the cell stack or the “jelly roll.” In particular a volume between 0.1 dm3 and 10 dm3 is enclosed by the cell housing. For example, the cell housing is additionally filled, at least in part, with an electrolyte. The cell housing preferably has a rigid design. In other words, the battery cell is in particular a prismatic cell. In particular, the cell housing is made of a metal, such as aluminum, i.e., pure aluminum or an aluminum alloy. The cell housing has a square shape, for example. Alternatively, the cell housing has a flexible design and is formed, at least in part, by a metal foil, for example, which in particular is coated on one or both sides. The metal foil envelops the electrodes, and is advantageously sealed at the ends so that escape of the electrolyte and/or entry of ambient air into the cell housing are/is avoided.

The electrodes are in particular situated directly in the cell housing, so that, for example, the electrodes rest against an inner wall of the cell housing, directly or via a further component, by which they are thus stabilized. The cell housing is used at least to directly protect the electrodes and/or to prevent contact of the electrodes/the electrolyte with ambient air or other particles. In other words, the electrodes within the cell housing are preferably not, at least not completely, enclosed by a further component, so that the weight of the battery cell and material costs are reduced. In particular, no further casing which encloses the electrodes is present in the cell housing. It is thus possible to fill the cell housing essentially completely by means of the electrodes and any separator(s).

The cell housing suitably has at least one or two apertures, through which a terminal is guided in each case. At least some of the electrodes situated in the cell housing are electrically contacted by means of the terminal(s), depending on the interconnection of the electrodes, so that supplying and/or removal of electrical energy from outside the cell housing to or from the galvanic elements formed by the electrodes is possible via the terminal(s). If only a single terminal is present, at least some of the electrodes are electrically contacted with the cell housing, so that an electrical potential of the cell housing is specified by these electrodes. In particular, the terminal(s) is/are electrically insulated from the cell housing, the terminals being connected to the cell housing in a fluid-tight manner so that escape of the electrolyte in the area of the terminals is avoided.

The cell housing has an opening that is circular or rectangular, for example. In particular, a surface area of the opening is between 50 μm2 and 15 mm2, preferably between 0.2 mm2 and 3 mm2. The opening is covered by means of a diaphragm that is gas-permeable. In particular, the diaphragm is rigidly attached to the cell housing, so that movement of the diaphragm relative to the cell housing is avoided. The diaphragm has a larger surface area than the opening, so that the diaphragm completely overlaps the opening. In particular, the surface area of the diaphragm is smaller than the surface area of any side of the cell housing that has the opening. Material costs are reduced in this way.

The attachment of the diaphragm to the cell housing preferably takes place in a fluid-tight and/or gas-tight manner, so that passage of liquids and/or gas between the diaphragm and the cell housing and through the opening is avoided. The diaphragm is particularly preferably welded to the cell housing, suitably with a circumferential weld seam. Alternatively, for example the diaphragm is joined to the cell housing in a form-fit and/or integrally bonded manner, in particular adhesively bonded. The opening is advantageously completely enclosed by means of the adhesive or the weld seam. For example, the connection takes place directly adjacent to the opening, or a space is formed between the opening and the attachment of the diaphragm to the cell housing, for example the adhesive or weld seam. As a result, it is possible for gas to enter or exit the cell housing only through the opening, the gas also being guided by the diaphragm.

In particular, the diaphragm is selected in such a way that it is preferably permeable at least to CO, CO2, H2, and/or CH4. For example, by use of the diaphragm there is comparatively little or no hindrance of such gases passing through. However, the permeability of the diaphragm to moisture, in particular water vapor, is lower. In particular, the diaphragm has a ratio of CO2 permeability to moisture permeability that is at least 0.5 or at least 1 or at least 1.5. The ratio is preferably greater than 0.5 and less than 3. In summary, the diaphragm is designed in such a way that gases arising in the cell housing can pass through the diaphragm and the opening and out of the cell housing, for which purpose the opening is used. The diaphragm impedes the entry of moisture, in particular water vapor, into the cell housing.

On the outside, i.e., offset outwardly in relation to the cell housing, the diaphragm is covered by a cover element. By use of the cover element, at least the portion of the diaphragm that covers the opening is covered. In particular, the opening is covered by means of the cover element. It is possible for the cover element to likewise be situated inside the cell housing, but offset in relation to the diaphragm, toward the opening. Alternatively, the cover element is situated outside the cell housing. For example, the cover element rests against the cell housing and/or the diaphragm, or is spaced apart from one or both of them. In particular, the cover element is rigid, at least in part. The cover element is used to restrict the entry of matter, in particular moisture, in particular water vapor, into the cell housing, and is suited, in particular provided and configured, for this purpose. The entry of matter through the diaphragm is preferably also restricted by the cover element. In other words, the cover element in particular sets how much, and/or whether, a material such as a liquid or preferably a gas, enters the cell housing via the diaphragm and through the opening. Stated differently, the opening is preferably at least temporarily closed by means of the cover element. The cover element is preferably designed at least so that it restricts or at least temporarily restricts, and thus sets, the passage of gas through the diaphragm and the opening. The cover element is preferably fluid-tight, for example continuously, or at least when it is in a specified state such as a closed state. In other words, in this state the passage of liquid, in particular water, is largely excluded, preferably due to inherent properties and/or by design. If or as long as no gases form within the cell housing, the cover element is preferably in the specified state.

Due to the opening and the diaphragm, it is possible for gases that arise in the cell housing to escape, so that the development of excessive pressure within the cell housing, which could result in damage to the electrodes and/or the cell housing, is avoided. Operational reliability is thus increased. Only the diaphragm and the cover element are necessary for this purpose, for which only a comparatively small volume is required. In addition, it is possible for the cover element to be situated outside the cell housing so that the energy density is not adversely affected. Due to the cover element, the diaphragm is at least partially protected from environmental influences from outside the cell housing, so that damage to the diaphragm is avoided. In addition, by means of the cover element, for example particles from the surroundings are at least temporarily/partially kept away from the diaphragm, in particular in the specified state when the cover element completely prevents the entry and/or exit of gas. Thus, the diaphragm is not acted on by liquid, in particular water vapor, from outside the cell housing, so that despite continuing, although reduced, permeability of the diaphragm to liquids, their penetration is completely prevented. On the other hand, if the cover element temporarily allows exit of gas from the cell housing, during this time period it is also possible, for example, for water to penetrate to the diaphragm; however, this is a comparatively small quantity which can be essentially completely held back by the diaphragm. The penetration of water into the cell housing is thus almost entirely prevented.

The diaphragm is in particular made of a polymer, for example a film such as a polymer film. The diaphragm is suitably manufactured from polytetrafluoroethylene (PTFE) or is made of same. The diaphragm advantageously has a crystallinity between 85% and 100% and a density between 0.2 g/cm3 and 2 g/cm3. Gas permeability is present with such a material selection, and penetration of moisture, in particular water vapor, into the cell housing is prevented or at least impeded by means of the diaphragm. In particular, a diaphragm described in WO 2021/079163 A1 is used as the diaphragm.

For example, the opening is positioned at any desired location at the cell housing. However, when the battery cell is designed as a pouch cell, the opening is particularly preferably situated in the area of one of the ends of the cylindrical shape, near the arrester, in which a possible film is in particular sealed (on the so-called gas pocket, for example). The opening is thus advantageously offset inwardly from the respective ends, up to a maximum of one-third of the maximum length of the cell housing.

If the battery cell is a prismatic cell, the opening is preferably situated in the area of the end-face sides and/or narrow sides, which in particular are not in parallel to the electrodes that are layered to form a possible cell stack. Alternatively, the opening is situated in one of the sides of the cell housing that is parallel to the electrodes, but is preferably situated in an edge area, i.e., offset inwardly from the edge up to a maximum of one-third of the width of the side. The design is simplified by such a position of the opening, and it is not necessary to modify an existing design plan for the cell stack. In addition, the opening is thus situated in an area at which arising gases collect, so that comparatively efficient removal of the gases through the opening is made possible.

For example, the diaphragm is fastened at the outer side of the cell housing. Thus, by use of the diaphragm an interior space in the cell housing is not filled, so that a comparatively large volume is available there for the electrodes. A high capacity of the battery cell is thus further ensured. However, the diaphragm is particularly preferably fastened to an inner wall of the cell housing. In addition, under comparatively high pressure within the cell housing, the diaphragm thus does not undergo excessive outward bulging if immediate passage of the gas is not possible due to the design of the diaphragm. As a result, the diaphragm is stabilized by the inner wall, which increases robustness. In addition, in the event of excess pressure the diaphragm is pressed against the inner wall, thus preventing passage of gas between the cell housing and the diaphragm. It is thus only possible for the gas to exit through the diaphragm, which takes place in a controlled manner. In summary, in particular the diaphragm is situated at an outwardly or inwardly directed side of the cell housing.

For example, the cover element is actuated as a function of temperature. The cover element is advantageously designed in such a way that at a temperature below a limit value, entry and/or exit of gas are/is completely prevented, so that the cover element prevents the diaphragm from being acted on by a fluid from outside the cell housing. In contrast, if the temperature of the battery cell is higher than the limit value, the cover element is set in particular so that it does not prevent the escape of gas from the cell housing. In other words, the diaphragm is freed up. As a result, however, it is possible for moisture, in particular water vapor, from outside the cell housing to reach the diaphragm.

The limit value is advantageously between 25° C. and 60° C. As the result of such a limit value, the cover element is thus set in particular only when escape of gas is possible when the battery cell is operated, i.e., when electrical energy is supplied to the battery cell and/or removed from the battery cell. Gases that are to escape can arise only during this time period. In contrast, when the battery cell is not needed, the diaphragm is protected by the cover element.

Alternatively or in combination therewith, the cover element is actuated as a function of a pressure difference between a pressure outside the cell housing and a pressure in a space that is formed between the cover element and the diaphragm. In particular, a volume of this space is less than 4 cm3, 1 cm3, or 0.5 cm3. The pressure in the space between the cover element and the diaphragm is in particular equal to the pressure inside the cell housing, or is slightly reduced due to the diaphragm.

The cover element is in particular actuated in such a way that the escape of gas from the cell housing is possible or at least simplified when the pressure in the space is greater than the pressure outside the cell housing, for example by more than 0.1 bar, 0.5 bar, 1 bar, 2 bar, or 5 bar. Otherwise, the cover element is in particular closed, so that gas is completely prevented from escaping. The cover element also protects the diaphragm from liquids from outside the cell housing. Thus, protection of the diaphragm by the cover element is reduced only when the pressure on the side of the cover element facing the interior of the cell housing is increased compared to the pressure outside the cell housing. In this case, however, a flow direction of the gas is directed to outside the cell housing. Penetration of liquid up to the diaphragm is thus prevented due to the flow direction of the gas. When the pressure difference decreases, the velocity of the gas likewise decreases, so that penetration of moisture, in particular water vapor, would be possible. However, the cover element is reclosed, which likewise prevents the penetration of liquid.

For example, the cover element is or includes a porous element, with the pores in particular being open. For example, the porous element is a foamed ceramic. By means of the porous element, a path length that must be covered by the gas is increased, so that increased resistance to the exiting gas is provided. The escape of gas from the cell housing is thus restricted by the porous element. Due to the porous element, penetration of moisture, in particular water vapor, is also prevented or at least impeded, in particular as a result of capillary effects. For example, the porous element is completely impermeable to liquid and/or gas, at least in certain areas, for example at a side, so that a path to be covered by the gases and the liquid, and thus fluidic resistance, is further increased. In particular, the side of the porous element opposite from the opening is designed in such a way that a path to be covered by gases/liquid through the porous element is thus comparatively long. In particular, the porous element is essentially square, which simplifies manufacture.

The cover element particularly preferably includes a valve or is formed by same. The valve is actuated by means of an actuator, for example, such as a piezo actuator. It is thus possible to control the escape of gas from the cell housing, in particular as a function of certain conditions, for example a possible pressure difference. The cover element preferably has a sensor on the basis of which the actuator is controlled. Alternatively, the valve is spring-loaded, for example, in particular designed as a check valve. The valve is actuated in particular as a function of the pressure difference between the pressure prevailing outside the cell housing and the pressure in the space that is formed between the cover element and the diaphragm, i.e., when the pressure exceeds a certain limit value. It is thus possible to adapt to different applications and/or other specifications by exchanging the spring.

For example, the valve is a gas- and liquid-impermeable body that is diaphragm-like or diaphragm-shaped, for example. By means of the body, for example the opening or the diaphragm is completely covered when the cover element/valve is in the closed state. The cover element is transferred into the open state by longitudinal displacement, in particular perpendicular to the direction of extension of the body and/or of the diaphragm, and the body is preferably correspondingly supported. Due to the longitudinal displaceability, direct penetration of liquid to the opening is prevented, even in the open state of the cover element. Alternatively, the cover element is designed in the manner of a flap, and is thus supported in particular pivotably with respect to the cell housing and/or at the cell housing. For example, a possible element of the body is supported by means of a bearing, or an element of a film hinge is particularly preferably supported at the cell housing. The design is simplified in this way.

In one alternative, the cover element has a plastic layer, preferably a polymer layer, which for example is mounted directly on some other element such as a film. The polymer layer includes microstructures or nanostructures, i.e., structures having a linear extension between 100 μm and 1 nm. In particular, the structures repeat periodically, so that a pattern is formed. Manufacturing is thus simplified. The structures are flaps or grass filaments, for example. If grass filaments are involved, these are in particular directed away from the interior of the cell housing, so that in the event of increased pressure outside the cell housing or if a liquid appears thereon, they are pressed flatly against a base of the polymer layer so that the cover element has a comparatively seal-tight design. Alternatively or in combination therewith, the structures are adjustable by applying a voltage, for example, so that passage of gas and liquid is either enabled or prevented. The microstructures or nanostructures increase mechanical robustness and reduce space requirements.

In a further alternative, the cover element has multiple cover wings, for example two, three, four, five, or more cover wings. The number of cover wings is advantageously less than ten, thus simplifying the design. The cover wings are attached to the cell housing, for example fastened thereto directly, or indirectly via a further element. The cover wings are thus attached to the cell housing spaced apart from one another at different locations, namely, a particular connecting point. In particular, the connecting points enclose the opening. The cover wings are suitably attached only on one side. The cover wings at least partially overlap the diaphragm, in particular also the opening, or at least the portion of the diaphragm that covers the opening. In addition, the cover wings mutually overlap one another. In other words, each of the cover wings at least partially overlays one or more of the remaining cover wings.

The cover wings have a flexible design, i.e., are elastically deformable, and in particular the cover wings are made of a gas- and liquid-impermeable material. The cover wings are able to deform due to their flexible design, so that the diaphragm is freed up. The cover wings are thus mutually stabilized, so that on the one hand, unintentional bending of one of the cover wings does not result in freeing up of the diaphragm. In addition, the forces necessary for this purpose are comparatively high. Furthermore, a comparatively large creepage distance is provided by the mutual overlapping, so that penetration of liquid between the cover wings up to the diaphragm as well as escape of gas in the opposite direction are essentially prevented at the cover wings resting against the cell housing. However, by bending up all or at least some of the cover wings it is possible to free up the diaphragm and thus allow gas to escape.

The cover wings are particularly preferably attached to the outer side of the cell housing, so that pressing in of the cover wings, which could result in damage to the diaphragm, is avoided. For example, the cover wings are designed in such a way that they are bent by increased pressure on the sides of the diaphragm, so that escape of gas is made possible. Alternatively, the cover wings are made of two different materials, for example, which undergo contraction differently when the temperature increases. Thus, at an elevated temperature the cover wings curve, and the diaphragm and thus also the opening are freed up.

The battery cell particularly preferably includes a drying element for reducing moisture that penetrates into the cell housing through the opening. The drying element is suited, in particular provided and configured, for this purpose. Thus, as a result of the drying element, moisture such as water that penetrates despite the cover element is bound in the liquid or gaseous state, for example, so that an unintentional reaction with the electrodes situated in the housing and/or any electrolytes is prevented. The operational reliability is thus further increased. In particular, the drying element is designed in such a way that it causes binding of water, in particular absorption of water molecules.

For example, the drying element is situated in the area of the opening, and for example encloses it. In particular, the drying element has multiple silicon-containing groups that are attached to the diaphragm. In other words, the diaphragm is functionalized with the silicon-containing groups. The space requirements are thus reduced. The drying element particularly preferably has the shape of a diaphragm, and for example is loosely placed on the diaphragm or spaced apart from same. Due to the arrangement on the inner side of the diaphragm, by means of the drying element only that portion of the liquid, in particular water, that passes through the diaphragm into the interior of the cell housing is held back. In other words, the diaphragm is initially used to hold back the moisture/liquid, and the drying element is not used until afterward. A comparatively long operating period of the battery cell is thus made possible without suspending the functioning of the drying element.

For example, the diaphragm has a tear-resistant design. However, the diaphragm is particularly preferably designed in such a way that it tears when a pressure difference between a pressure outside the cell housing and a pressure inside the cell housing exceeds a limit value. Damage to the cell housing is thus avoided. For example, the diaphragm completely tears and breaks apart. The tearing advantageously takes place only when the limit value is exceeded. When the pressure difference once again falls below the limit value, in particular the tearing ends. Complete destruction of the diaphragm is thus prevented.

For example, the battery cell has multiple openings, each of which is covered by a corresponding gas-permeable diaphragm, each diaphragm being covered on the outer side with an associated cover element for restricting the entry of moisture into the cell housing. For example, multiple or all openings are covered by the same cover element. In particular, all openings/diaphragms/cover elements have identical designs, and differ only in their position at the cell housing. Alternatively, for example the cover elements and/or diaphragms have different designs, so that they have different permeabilities and/or are actuated at different pressure differences or under other conditions. Flexibility is thus increased.

However, the battery cell particularly preferably has only the single opening, which simplifies manufacture. In particular, the diaphragm, at least in the area of the opening, rests against a stabilizing element and is fastened thereto, for example. In other words, the stabilizing element overlays the opening, at least in part. The stabilizing element preferably has a rigid design and is made of a metal, for example. The stabilizing element is preferably fastened to the cell housing, suitably by welding. The stabilizing element has further openings, each of which is overlaid by the opening. The effective surface area that is available for gas to exit from the cell housing is thus limited to the sum of the further openings, so that even a comparatively large opening may be selected without excessive escape of gas from, or entry of liquid into, the cell housing taking place.

The stabilizing element is suitably offset outwardly in comparison to the diaphragm. A maximum deformation of the diaphragm is thus predefined by the further openings, and the diaphragm is stabilized in this way. For example, the stabilizing element is designed in such a way that it ruptures when there is an increased pressure difference between the pressure inside the housing and the pressure outside the cell housing. For this purpose the stabilizing element has, for example, one or more predetermined breaking points that are produced by a laser or a stamp, for example. The pressure difference at which this takes place is settable in each case in a comparatively precise manner. Alternatively or in combination therewith, the stabilizing element is designed in such a way that it ruptures when a certain temperature is exceeded. Due to the rupture the diaphragm is no longer stabilized and is thus likewise overloaded, so that it tears. As a result, it is possible for a comparatively large volume of gas to pass through the opening. In particular, in this case the cover element likewise ruptures, or is at least set in such a way that it is possible for gases to escape essentially unhindered. Controlled degassing of the battery cell thus takes place, and uncontrolled destruction of the cell housing due to excessive pressure is avoided. Although the battery cell is thus damaged and no longer usable, stress on the surroundings is reduced. In other words, the diaphragm and the stabilizing element act in the manner of a rupture disk.

As an alternative to or in combination with the examples described above, the cell housing suitably has an integrated predetermined breaking point. The integrated predetermined breaking point is, for example, spatially separate from the opening, or for example the integrated predetermined breaking point has the opening. In a further alternative, the predetermined breaking point is formed by the opening. For example, the predetermined breaking point is a surface area of the cell housing with a reduced wall thickness. Alternatively or in combination, the predetermined breaking point is, for example, a surface area of the cell housing with an engraving and/or notch. In one refinement, the predetermined breaking point is an additional opening in the cell housing that is closed by a rupture disk. In other words, the cell housing has the additional opening, which is completely closed by means of the rupture disk. The size of the predetermined breaking point is suitably between 0.01% and 50% of the surface area of the cell housing. The size of the predetermined breaking point is preferably between 0.1% and 40%, in particular between 0.3% and 30%, of the surface area of the entire cell housing. For example, the diaphragm has a surface area that is 50% larger than the opening.

For example, the diaphragm is situated at an inwardly directed side of the cell housing. For example, the diaphragm outside the openings is not completely in physical contact with the cell housing. In one alternative, a portion of the surface area of the diaphragm is spaced apart from the cell housing via spacers.

In a further alternative, the cell housing includes an auxiliary opening, for example, that is closed by a rupture disk which has the opening that is covered by the gas-permeable diaphragm. The rupture disk is formed, for example, by a reduction in the wall thickness of the cell housing, or by a component that is initially separate from the cell housing and fastened to the cell housing for assembly. The possible predetermined breaking point is formed in particular by means of the rupture disk. The diaphragm is preferably fastened at an outwardly directed side of the rupture disk. For example, on the outer side the diaphragm rests against a further stabilizing element, or the possible stabilizing element with multiple additional openings. The stabilizing element is preferably fastened to the rupture disk. In one alternative, the diaphragm is situated at an inwardly directed side of the rupture disk, a portion of the surface area of the diaphragm being supported on the rupture disk via spacers.

The invention further relates to a combination of such battery cells, the combination preferably being a battery module or a high-voltage battery. The invention further relates to a motor vehicle, such as a passenger car, that includes such a battery cell, in particular such a combination. The battery cell is used in particular for supplying power to a main drive of the motor vehicle.

The advantages and refinements described in conjunction with the battery cell are analogously transferable to the combination/the motor vehicle and among one another, and vice versa.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a simplified view of a motor vehicle that has multiple battery cells with an identical design,

FIG. 2 schematically shows a sectional illustration of one of the battery cells, which has a cell housing,

FIGS. 3 through 6 schematically show details of the cell housing, having an opening for gas to escape, at different pressures within the cell housing, the opening being covered by a gas-permeable diaphragm, and on the outer side the diaphragm being covered by a cover element for restricting the escape of gas from the cell housing,

FIGS. 7, 8 each schematically show an example of the battery cell,

FIGS. 9, 10 each show a top view of examples of a stabilizing element,

FIGS. 11 through 13 each schematically show an example of the battery cell, and

FIGS. 14 through 17 each schematically show an example of the cover element.

### DETAILED DESCIRPTION

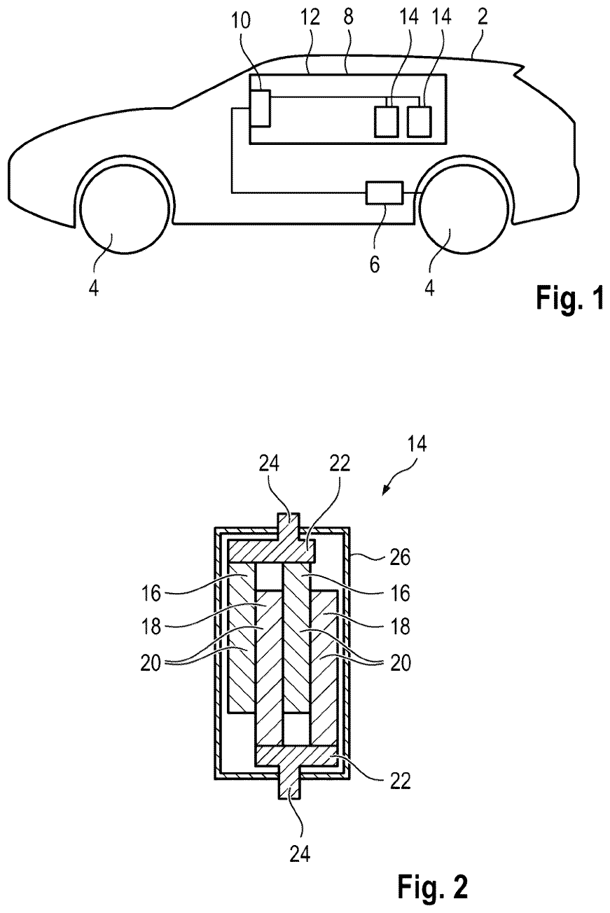

FIG. 1 schematically illustrates a simplified view of a motor vehicle 2 in the form of a passenger car. The motor vehicle 2 has a number of wheels 4, at least some of which are driven by means of a drive 6 that includes an electric motor. The motor vehicle 2 is thus an electric vehicle or a hybrid vehicle. The drive 6 has a converter by means of which the electric motor is supplied with power. The converter of the drive 6 is in turn supplied with power by an energy store 8 in the form of a high-voltage battery. For this purpose, the drive 6 is connected to an interface 10 of the energy store 8 that is introduced into an energy store housing 12 of the energy store 8 made of a stainless steel.

Multiple battery modules having an identical design, not illustrated in greater detail, and including multiple battery cells 14 in each case are situated within the energy store housing 12 of the energy store 8. The battery cells 14 of each battery module are in part electrically connected to one another in series, and are in part electrically connected to one another in parallel. The battery modules in turn are electrically connected to one another in series and/or in parallel. The electrical combination of the battery modules is electrically contacted with the interface 10, so that during operation of the drive 6, charging or discharging (recuperation) of the battery modules, and thus also of the battery cells 14, takes place. Due to the electrical interconnection, the voltage provided at the interface 10, which is 400 V or 800 V, is a multiple of the voltage provided by each of the battery modules and also by each of the battery cells 14.

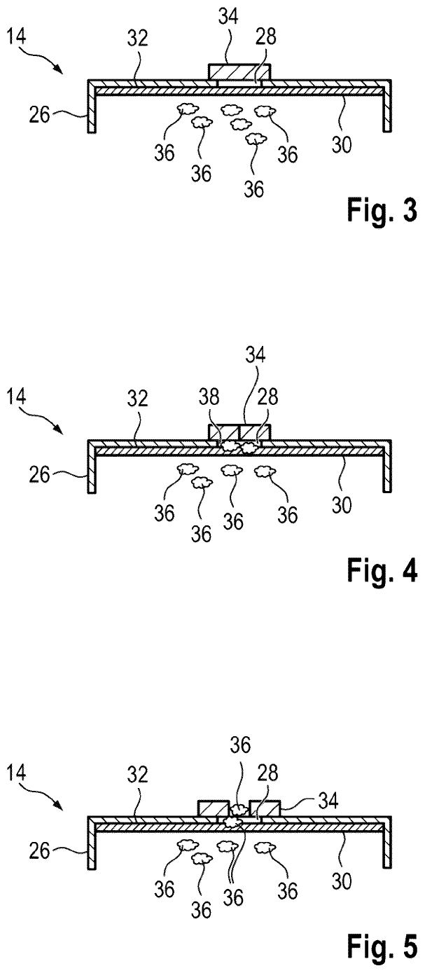

FIG. 2 shows a sectional illustration of one of the battery cells 14 having an identical design. The battery cell 14 has multiple anodes 16 and cathodes 18, only two of each being illustrated. The anodes 16 and the cathodes 18, which form the electrodes 20 of the battery cell 14, each have a flat design and are layered one on top of the other in alternation to form a cell stack, with a separator being situated in each case between neighboring anodes 16 and cathodes 18. The anodes 16 on a shared side protrude beyond the cathodes 18, namely, in each case a respective arrester that is formed by a respective metal foil. In the area of the overhang, the particular arrester is free of further components, but in the other areas a layer, also referred to as a carrier, that includes an active material is applied to the particular arrester. The cathodes 18 similarly protrude beyond the anodes 16, with the overhangs being situated on opposite sides of the stack formed by the anodes 16 and cathodes 18.

The overhangs of the anodes 16 and of the cathodes 18 are each welded to a busbar 22 (tab) made of copper. A shared busbar 22 is associated in each case with the anodes 16 and the cathodes 18. The busbars 22 each have a terminal 24 that is led through a cell housing 26, inside of which the anodes 16 and the cathodes 18 are situated. In other words, the electrodes 20 are situated inside the cell housing 26. The cell housing 26 has a rigid design, and is made of an aluminum, i.e., an aluminum-containing material. The battery cell 14 is thus a prismatic cell. The cell housing 26 is filled with a liquid electrolyte.

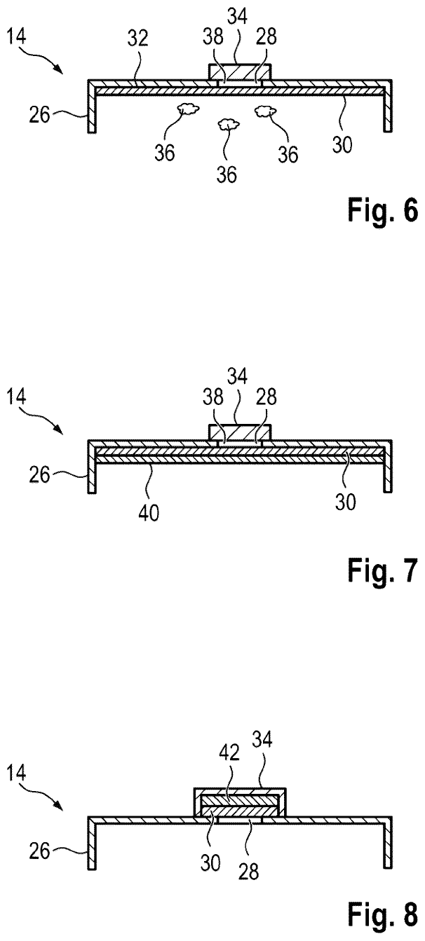

FIGS. 3 through 6 schematically show details of the battery cell 14 in a sectional illustration during operation. The cell housing 26 has an opening 28 having a surface area of 50 mm2. The opening 28 is situated in the same wall of the cell housing 26 in which the aperture for one of the terminals 24 is also introduced. Except for the opening 28, the cell housing 26 has a fluid-tight and gas-tight design. Thus, the areas between the terminals 24 and the associated apertures in the cell housing 26 are filled with a plastic.

The opening 28 is covered by a gas-permeable diaphragm 30 that is fastened, namely by welding or adhesive bonding, to the inner wall 32 of the cell housing 26 that has the opening 28. In the illustrated example, the diaphragm 30 overlays the entire inner wall 32 of the housing 26, and thus also completely covers the opening 28. The diaphragm 30 is made of PTFE, at least in part. Passage of the gases H2, CO, CH4, and CO2 through the diaphragm 30 is thus possible with comparative ease, whereas passage of moisture, in particular water vapor, and other liquids is more difficult in comparison. The diaphragm 30, namely, the portion that covers the opening 28, is covered by a cover element 34 on the outer side in relation to the cell housing 26. The cover element 34 is situated at the outer side of the cell housing 26 and is fastened thereto. The cover element 34 is gas- and liquid-tight, and is used to restrict the entry of gas into the cell housing 26. Penetration of moisture, in particular water vapor, from the surroundings into the opening 28 and thus also to the diaphragm 30 is thus completely prevented by the cover element 34.

During operation of the battery cell 14, it is possible for gases 36 such as H2, CO, CH4, and/or CO2 to form in the cell housing 26 due to unwanted chemical reactions, for example on account of a comparatively high load or undesirable foreign particles. The gases 36 require a larger volume than the reaction materials, so that pressure inside the cell housing 26 rises. As shown in FIG. 4, it is possible for the gases 36 to pass through the diaphragm 30 and into the opening 28, i.e., a space 38 that is formed between the cover element 34 and the diaphragm 30, and which in this example is defined by the opening 28.

When the pressure difference between the pressure outside the cell housing 26 and the pressure in the space 38 exceeds a limit value, for example 0.5 bar, the cover element 34 is actuated so that it is partially opened. As a result, gas escapes from the space 38 into the surroundings of the cell housing 26, as shown in FIG. 5. In addition, gases 36 continue to flow from the interior of the cell housing 26, through the diaphragm 30 and the opening 28, and into the surroundings. Entry of moisture into the cell housing 26 is hereby avoided by means of the diaphragm 30 (also see the following discussion).

When the pressure difference between the pressure in the space 38 and the pressure outside the cell housing 26 has dropped down again because the gases 36 have at least partially escaped, the cover element 34 is once again closed so that further exit of the gases 36 from the space 38, and thus from the cell housing 26, no longer takes place, as illustrated in FIG. 6. Thus, once again the diaphragm 30 is subsequently completely covered by the cover element 34, so that entry of moisture into the opening 28 is avoided.

Due to the design of the battery cell 14, entry of moisture from outside the battery cell 26 to the electrodes 20 would be possible only if the cover element 34 were actuated in such a way that passage of gas was possible. In this case, however, the gases 36 flow from the interior of the cell housing 26 to the outside, so that penetration of moisture is prevented or at least greatly reduced due to the flow movement of the gases 36.

The actuation of the cover element 34 additionally or alternatively can take place solely as a function of the temperature of the battery cell 14. In this case, the cover element 34 is actuated so that the gases 36 are able to escape when the temperature of the battery cell 14 exceeds a limit value, for example 40° C.

The diaphragm 30 is also designed in such a way that it tears when the pressure difference between the pressure outside the cell housing 26 and a pressure inside the cell housing 26 exceeds a (further, higher) limit value. The limit value, i.e., the further limit value, is 10% to 25% lower than the maximum pressure load on the cell housing 26, i.e., the pressure difference that occurs during irreversible destruction of the cell housing 26. This pressure difference is in particular between 6 bar and 8 bar. In other words, the diaphragm 30 acts as a rupture diaphragm that tears to avoid destruction of the cell housing 26.

Thus, when a comparatively large volume of gases 36 is formed, the gases enter the space 28, so that the cover element 34 is actuated. As a result, the pressure in the space 28 essentially corresponds to the pressure in the surroundings of the cell housing 26, i.e., the pressure outside the cell housing 26. If the pressure difference between the pressure in the space 28 and the pressure inside the cell housing 26 then exceeds the further limit value, the diaphragm 30 tears in a controlled manner, so that escape of the gases 36 from the interior of the cell housing 26 into the surroundings is accelerated due to the absent or reduced fluidic resistance of the diaphragm 30. Damage to the housing 26 due to the excessive pressure inside the cell housing 26 is thus avoided.

The tearing of the diaphragm 30 stops when the pressure difference has once again fallen below the further limit value. In addition, when the majority of the gases 36 have escaped, so that the pressure difference between the surroundings of the cell housing 26 and the pressure in the space 28 falls below the limit value of 0.5 bar, the cover element 34 is once again actuated, which causes the opening 28 to be completely covered. Penetration of moisture into the cell housing 26 in turn is avoided by means of the cover element 34. As a result, further operation of the battery cell 14 is also possible, although due to the torn diaphragm 30, penetration of liquid, at least temporarily and in part, is made possible.

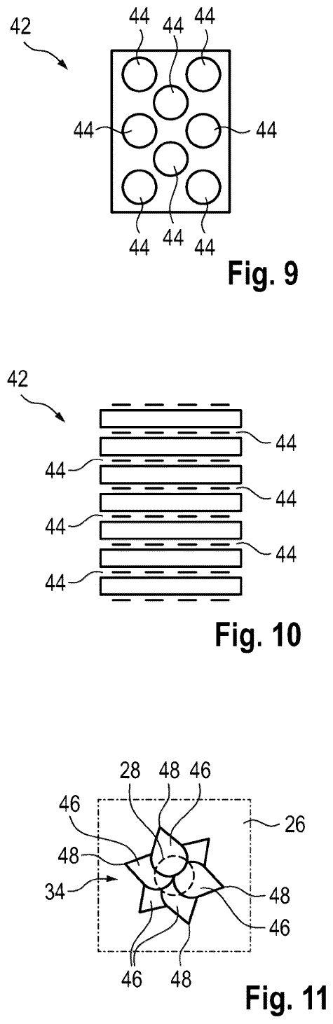

FIG. 7 shows a modification of the battery cell 14 according to the illustration in FIG. 3. In this variant, the battery cell 14 has a drying element 40. The drying element 40 is made of silicon-containing groups, and is present as a layer by means of which the diaphragm 30 is coated and thus covered flatly on the inner side, namely, over the entire surface area in this variant. In other words, the drying element 40 is present as a layer that is separate from the diaphragm 30. There is little or no hindrance of passage of the gases 36 by the drying element 40. However, the moisture, namely, water (vapor), that still passes through the opening 28 and reaches the diaphragm 30 is bound and/or absorbed by means of the drying element 40, so that the moisture cannot pass to the electrodes 30 and/or the electrolyte. The drying element 40 thus serves to reduce the moisture that penetrates into the cell housing 26 through the opening 28.

FIG. 8 shows a further modification of the battery cell 14 according to the illustration in FIG. 3. In this variant, the opening 28 is covered at the outer side by the diaphragm 30, and the diaphragm 30 is fastened at the outer side of the cell housing 26, namely, by welding or adhesive bonding. In addition, the battery cell 14 includes a stabilizing element 42 made of a metal. The stabilizing element 42 has a flat design and rests with its full surface area against the diaphragm 30. As a result, the diaphragm 30 also rests against the stabilizing element 42 in the area of the opening 28. The diaphragm 30 is situated between the cell housing 26 and the stabilizing element 42, which is thus offset outwardly in relation to the diaphragm 30.

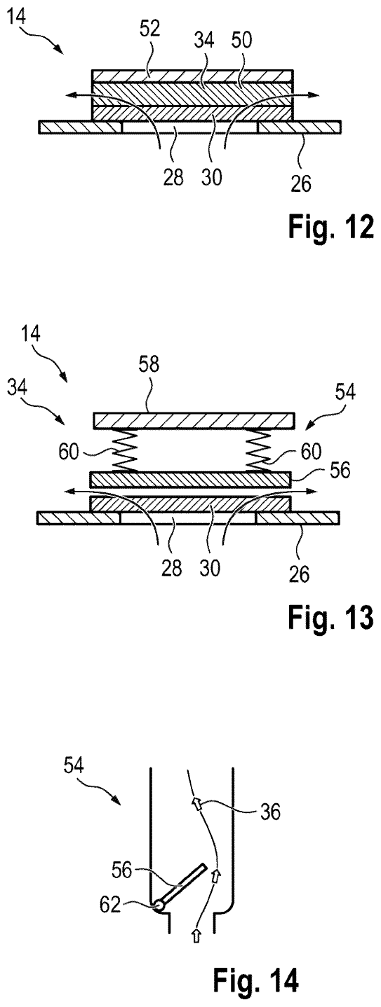

FIGS. 9 and 10 each illustrate a top view of an example of the stabilizing element 42. The stabilizing elements each have multiple further openings 44. In the variant illustrated in FIG. 9, the further openings 44 are separate from one another and are provided via circular recesses. In the variant illustrated in FIG. 10, the further openings 44 are strip-shaped.

The further openings 44 or at least a portion of them in each case are situated above the opening 28, and the further openings are thus overlaid by the opening 28. The stabilizing element 42 and thus also the diaphragm 30 are covered over their full surface area by the cover element 34, which likewise is situated outside the cell housing 26. When the pressure rises within the cell housing 26 and the cover element 34 is at least partially open, the diaphragm 30 bulges out slightly only in the areas of the further openings 44, so that excessive deformation of the diaphragm 30 is avoided. The stabilizing element 42 ruptures only when the pressure difference between the interior of the cell housing 26 and the surroundings of the cell housing 26 exceeds the further limit value, namely, 6 bar to 8 bar, as a result of which no further stabilization of the diaphragm 30 occurs and the diaphragm thus tears, so that it is possible for a comparatively large volume of the gases 36 to escape unhindered.

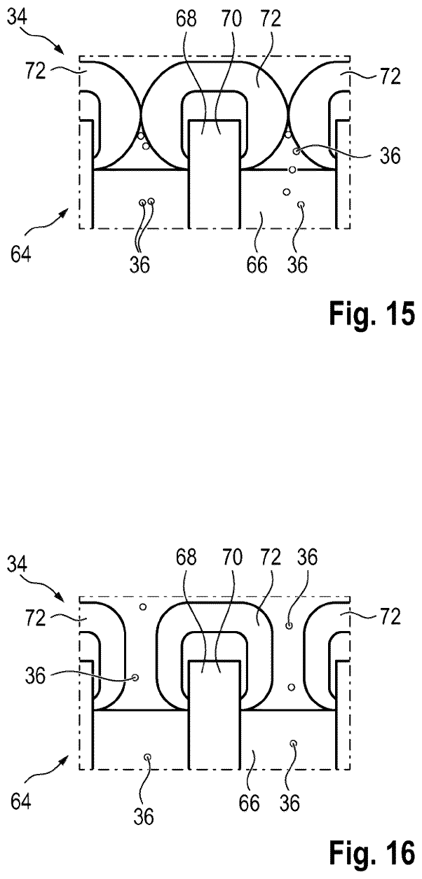

FIG. 11 illustrates a variant of the cover element 34 in a top view. The cover element 34 has multiple cover wings 46 that are attached, namely fastened, to the cell housing 26 at spaced-apart connecting points 48. The connecting points 48 surround the opening 28, and the cover wings 46 are arranged in such a way that at the end opposite from the respective connecting point 48, they overlay one another and the opening 28, at least in part, and therefore also overlay the diaphragm 30. The cover wings 46 have a flexible design and are made of a polymer, for example. When the pressure difference exceeds the limit value, due to the increased pressure the cover wings 46 are lifted up from the cell housing 26, which they otherwise contact flatly, at the free end that is spaced apart from the respective connecting point 48, so that gas is able to escape. In contrast, if the pressure difference is smaller, escape of gas from within the cell housing 26 and/or entry of moisture from outside the cell housing 26 into the opening 28 or at least to the diaphragm 30 are/is prevented due to the comparatively large creepage distance that is provided via the overlap. In one alternative, the cover wings 46 are made of two different materials having different temperature behaviors. The material of the portion of the cover wing 46 facing the outer side of the cell housing 26 is selected in such a way that it increasingly contracts when the temperature rises. Consequently, at an elevated temperature the cover wings 46 are deformed in such a way that the opening 28 and thus the diaphragm 30 are freed up.

FIG. 12 shows, once again in a sectional illustration, a partial, schematically simplified view of the battery cell 14. In this variant, the opening 28 is once again covered on the outer side by the diaphragm 30. The diaphragm 30 in turn is completely covered by the cover element 34, which includes a porous element 50, namely, a foamed ceramic or a foamed material. The porous element 50 has multiple pores that are open. Due to the pores, gas is able to pass through, this passage being restricted on account of the increased fluidic resistance.

On the side opposite from the diaphragm 30, the square porous element 50 is provided with a layer 52 having a completely fluid-tight design. The layer 52 ensures that the escaping gases 36 take a comparatively long path through the porous element 50 to the exit; the installation size of the cover element 34 is not excessively increased. The layer 52 also ensures that incoming water likewise reaches the opening 28 only after a comparatively long path through the porous element 50, which is delayed relatively greatly due to the capillary effect.

FIG. 13 illustrates a further embexampleodiment of the battery cell 14 according to FIG. 12. Here as well, the diaphragm 30 is situated at the outer side of the cell housing 26 and overlays the opening 28. The cover element 34 is also situated at the outer side of the housing 26. The cover element 34 includes a valve 54, and in the illustrated example is formed by the valve. The valve 54 has a fluid-impermeable body 56 that is shaped in such a way that it encloses the entire diaphragm 30 when the body 56 rests against the cell housing 26 at the edges. The body 56 is made of a plastic, and by means of guides, is supported so that it is longitudinally displaceable perpendicular to the surface area of the diaphragm 30. In addition, the body is supported on a stop 58 by multiple springs 60, the body 56 being situated between the stop 58 and the diaphragm 30. The springs 60 are designed in such a way that they cause the body 56 to be pressed against the diaphragm 30 and the cell housing 26 as long as the pressure difference between the pressure inside the housing 26 and the surroundings of the cell housing 26 is less than the limit value of 0.5 bar. When the limit value is exceeded, due to the pressure the body 56 is spaced apart from the diaphragm 30 via the force applied by the springs 60, thus allowing the gases 36 to escape.

The springs 60 can be replaced by an actuator, or the actuator is additionally present. The actuator, such as a piezo actuator or a magnetic element, is actuated for spacing the body 56 apart from the diaphragm 30 when certain conditions, for example a certain temperature rise, are present.

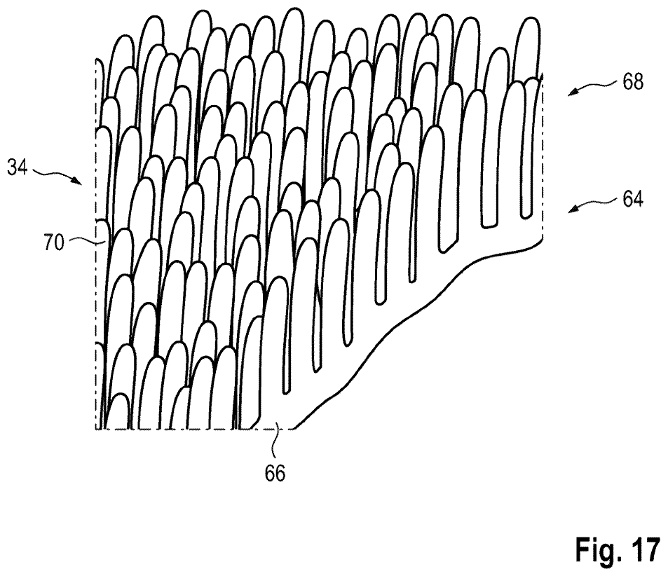

FIG. 14 illustrates an example of the valve 54. In this example, the body 56 is pivotably supported on further components of the cover element 34 or the cell housing 26 by means of a hinge 62, such as a film hinge. In one variant, the valve 54 is designed in the manner of a check valve, so that liquid impinging on the body 56 from the outside results in closing of the valve 54. Tthe body 56 can also be subjected to load by the springs 60, which cause the body 56 to be pushed or pulled into the closed position when the pressure difference is less than the limit value. In a further variant, the body 56 is additionally or alternatively actuated by means of the actuator.

FIGS. 15 and 16 illustrate a modified form of the cover element 34. In one alternative, the polymer layer 64 is applied to a separate component, or a further diaphragm is formed by means of the polymer layer 64. The polymer layer 64 has a base 66 to which multiple nanostructures 68 are fastened. The nanostructures 68 are each spaced apart from one another by 200 nm and are arranged in a repeating pattern. Each nanostructure 68 has a stud 70, fastened to the base 66 and pointing away from same, to which a thickened area 72 is attached on the free end opposite from the base 66. The extension of the thickened area 72 is a function of an applied voltage. In the normal state of the cover element 34, i.e., when no voltage is present, the thickened areas 72 are distended in such a way that neighboring thickened areas 72 rest against one another in each case, so that it is not possible for the gases 36 to pass through, as shown in FIG. 15. In contrast, if a voltage is applied, the thickened areas 72 contract so that neighboring thickened areas 72 are spaced apart from one another. As a result, the gases 36 are able to pass through, as shown in FIG. 16.

FIG. 17 shows a modification of the cover element 34 which likewise is formed by means of the polymer layer 64. In this case, however, the nanostructures 68 are designed as grass microfilaments. In other words, the individual studs 70 merely protrude from the base 66, and have a comparatively flexible design. The studs 70, the same as in the previous example, point away from the cell housing 26 or to the outside. When liquid drops impinge from the outside, the studs 70 are bent over on the base 66, so that the studs 70 are situated on top of and next to one another. Passage of the moisture is thus avoided. As soon as the moisture is removed, the studs 70 essentially resume their original position. It is always possible for the gases 36 to pass through from the opposite direction when the studs 70 are straightly aligned.

The shape of the studs 70 can be modified, and they have a shortened and/or conical design, for example. The studs 70 can be enlarged, so that the polymer layer 64 has microstructures instead of the nanostructures 68. In other words, the size of the studs 70 and their distance from one another are increased. However, the shape of the studs 70 is essentially unchanged.

The invention is not limited to the examples described above. Rather, other variants of the invention may also be deduced by those skilled in the art without departing from the subject matter of the invention. In particular, all individual features described in conjunction with the individual examples may also be combined with one another in some other way without departing from the subject matter of the invention.

What is claimed is:

1. A battery cell comprising:
a cell housing in which at least two electrodes are arranged; and
an opening that is covered by a gas-permeable diaphragm, an outer side of the diaphragm being covered by a cover element in order to restrict an entry of matter into the cell housing.

2. The battery cell according to claim 1, wherein the diaphragm is fastened to an inner wall of the cell housing.

3. The battery cell according to claim 1, wherein the cover element is actuated as a function of a pressure difference between a pressure outside the cell housing and a pressure in a space that is formed between the cover element and the diaphragm.

4. The battery cell according to claim 1, wherein the cover element includes a valve.

5. The battery cell according to claim 1, wherein the cover element includes a polymer layer with microstructures or nanostructures.

6. The battery cell according to claim 1, wherein the cover element includes multiple flexible cover wings that overlap one another and the diaphragm, at least in part, and that are attached to the cell housing spaced apart from one another.

7. The battery cell according to claim 1, further comprising a drying element for reducing moisture that penetrates into the cell housing through the opening.

8. The battery cell according to claim 7, wherein the diaphragm on an inner side is flatly covered by the drying element.

9. The battery cell according to claim 1, wherein the diaphragm is designed in such a way that it tears when the pressure difference between a pressure outside the cell housing and a pressure inside the cell housing exceeds a limit value.

10. The battery cell according to claim 1, wherein the diaphragm in the area of the opening rests against a stabilizing element that has further openings, each of which being overlaid by the opening.
